(19) United States
(12) Patent Application Publication
(10) Pub. No.: US 2026/0103201 A1
(43) Pub. Date: Apr. 16, 2026

(54) CONTROL ARRANGEMENT AND METHOD FOR CONTROLLING WHEEL SLIP

(71) Applicant: Scania CV AB, Södertälje (SE)

(72) Inventors: Jonathan Adolfsson, Bandhagen (SE); Anders Kjell, Ekerö (SE)

(73) Assignee: Scania CV AB, Södertälje (SE)

(21) Appl. No.: 19/349,543

(22) Filed: Oct. 3, 2025

(30) Foreign Application Priority Data
Oct. 10, 2024 (SE) 2451008-3

(51) Int. Cl. B60W 30/18; B60W 40/068

(52) U.S. Cl. CPC B60W 30/18172; B60W 40/068; B60W 2552/40; B60W 2710/06; B60W 2720/26

(57) ABSTRACT

Disclosed are a control arrangement and method for controlling wheel slip in a vehicle comprising a plurality of mechanically independent powertrains. The plurality of mechanically independent powertrains comprises, as seen in a driving direction of the vehicle, a leading powertrain, and at least one trailing powertrain. The method comprises monitoring of estimated road friction for the leading powertrain and estimated road friction for the at least one trailing powertrain. When a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, the method comprises reducing a maximum allowable wheel slip for the leading powertrain and controlling the leading powertrain in dependence of the reduced maximum allowable wheel slip.

### TECHNICAL FIELD

The present disclosure relates in general to a method for controlling wheel slip in a vehicle. The present disclosure further relates in general to a control arrangement configured to control wheel slip in a vehicle, and a vehicle comprising said control arrangement.

The present disclosure further relates in general to a computer program as well as a computer-readable medium.

### BACKGROUND

Traditionally, vehicles have been equipped with a single powertrain configured to provide motive power to the vehicle via wheels arranged at one or more wheel axles of the vehicle. Wheels that are, or at least can be, operably connected to a power source of the vehicle are normally referred to as drive wheels (or driven wheels), whereas wheels that cannot be operably connected to a power source are normally referred to as non-driven wheels. A wheel axle comprising drive wheels is therefore usually referred to as a drive axle (or a driven axle). In most cases, wheels arranged at two opposite lateral sides of a wheel axle are usually connected via a differential to the rest of the powertrain to thereby allow the wheels to rotate at different speeds when needed. Some vehicles, and especially heavy road vehicles (such as trucks and busses), can comprise two or more drive axles albeit comprising a single powertrain. Such vehicles normally further comprise a longitudinal differential allowing wheels of the two or more drive axles to rotate at different speeds, when needed. One example of a situation where the drive wheels of the vehicle may need to rotate at different speeds is while cornering.

In vehicles equipped with multiple drive axles, road conditions can sometimes cause the wheels of a leading drive axle, as seen in the direction of travel of the vehicle, to affect the traction of a following drive axle. For example, when driving on icy roads or loose gravel, the wheels of the leading drive axle may polish or otherwise damage the road surface. As a result, the wheels of the following drive axle may encounter considerably lower road friction compared to the wheels of the leading drive axle, which in turn typically leads to a loss of traction. This phenomenon is particularly common during winter conditions or off-road driving, where maintaining substantially consistent traction across all drive axles may be important for vehicle stability and performance.

Several solutions exists to address the issue of reduced traction on following drive axles. For example, the vehicle may comprise an inter-axle differential lock configured to lock the longitudinal differential between drive axles and thereby distribute power evenly across the drive axles to prevent one of the drive axles from spinning if it loses traction. Moreover, modern vehicles usually comprises traction control systems. Such systems may usually be configured to automatically detect when a wheel loses grip and adjust power output of the power source and/or apply brakes to the slipping wheel(s), to thereby redistribute power to wheels with better traction.

An effect of the drive toward electrification of vehicles for environmental reasons is that the number of vehicles comprising several power units, each configured to provide motive power to the vehicle, has increased. Examples of such vehicles include hybrid vehicles, comprising at least one electric motor and e.g., a combustion engine, and fully electric vehicles comprising a plurality of electric motors. Furthermore, and perhaps more importantly, vehicles comprising two or more mechanically separated powertrains have been developed. Examples thereof include vehicles comprising two or more electric drive axles (often called e-Axles), or vehicles comprising a conventional combustion engine powertrain in combination with at least one electric drive axle. Electrically driven trailers (so called E-trailers) are also being developed which, when connected to a tractor vehicle, results in a vehicle combination comprising a plurality of mechanically separated powertrains. Vehicles equipped with a plurality of mechanically separated powertrains can utilize the powertrains in different ways to achieve, for example, improved energy efficiency and/or performance or a higher power demand. However, like traditional vehicles comprising a single powertrain, vehicles comprising a plurality of mechanically separated powertrains may still encounter situations where a leading drive axle may polish or otherwise damage a surface travelled by the vehicle such that the trailing drive axle suffers a reduction, or even loss, of traction.

### SUMMARY

The object of the present invention is to overcome a situation where a trailing powertrain of a vehicle suffers from a reduction or loss of traction as a result of a leading powertrain of the vehicle polishing or otherwise damaging the surface travelled by the vehicle.

The object is achieved by the subject-matter of the appended independent claim(s).

The present disclosure provides a method, performed by a control arrangement, for controlling wheel slip in a vehicle. The vehicle comprises a plurality of mechanically independent powertrains, each of said powertrains being configured to provide propulsion force to the vehicle via a respective set of drive wheels. The plurality of mechanically independent powertrains comprises, as seen in a driving direction of the vehicle, a leading powertrain and at least one trailing powertrain. The method comprises a step of monitoring of estimated road friction for the leading powertrain and estimated road friction for the at least one trailing powertrain. The method further comprises a step of, when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reducing a maximum allowable wheel slip for the leading powertrain. Moreover, the method comprises a step of controlling the leading powertrain in dependence of the reduced maximum allowable wheel slip for the leading powertrain.

The herein described method addresses a situation where a trailing powertrain of a vehicle may suffer from a relative sudden reduction or loss of traction due to drive wheels of a leading powertrain polishing or otherwise damaging the surface travelled by the vehicle through utilization of the advantage of being able to independently control mechanically independent powertrains. The herein described method allows for reducing an actual wheel slip of the leading powertrain, which in turn is achieved by reducing the maximum allowable wheel slip for the leading powertrain. A maximum allowable wheel slip for the leading powertrain is a control parameter which affects how the leading powertrain may be controlled in order to ensure that the actual wheel slip of the leading powertrain is equal to or lower than said maximum allowable wheel slip while striving towards meeting a total motive force demand for the vehicle. A reduction of wheel slip of the leading powertrain reduces the damage caused by the leading powertrain on the surface travelled by the vehicle that leads to loss of road friction for the trailing powertrain. In other words, the road friction for the at least one trailing powertrain may be improved through controlling the leading powertrain to have a lower wheel slip. This in turn enables more of the propulsion force generable by the at least one trailing to contribute to the total motive force provided to the vehicle and thereby also for an improved force distribution between the plurality of mechanically independent powertrains to meet a total motive force demand for the vehicle. In other words, by means of the herein described method, it is possible to achieve a greater total motive force for the vehicle compared to if only maxing out the motive force achievable by the leading powertrain.

As evident from the above, the herein described method considers the difference in estimate road friction for the leading powertrain and the estimated road friction for the at least one trailing powertrain. The reason therefore is that road friction may vary greatly over time and driving conditions, including for example weather conditions, road conditions, and/or tire wear. In order to be able to determine that it is the leading powertrain that causes the loss of traction for the trailing powertrain and thereby actions that may be taken to overcome the problem, it is therefore relevant to consider the difference in estimated road friction between the leading powertrain and the at least one trailing powertrain. However, said difference may still not sufficient to determine that that the leading powertrain is the cause for the reduced or lost traction of the at least one trailing powertrain. The herein described method therefore considers the derivative of the difference between the estimated road friction for the leading powertrain and the estimated road friction for the at least one trailing powertrain. This also has the advantage of enabling to more quickly address the situation. In many instances, the herein described method will therefore be able to improve traction for the at least one trailing powertrain even before, for example, a driver of the vehicle may notice a loss of total motive force for the vehicle.

The method may further comprise a step of, when the estimated road friction for the at least one trailing powertrain drops to substantially zero while the leading powertrain has a wheel slip above a first limit, reducing the maximum allowable wheel slip for the leading powertrain. A relatively high wheel slip of the leading powertrain in combination with a drop of estimated road friction for the at least one trailing powertrain is a clear indication that the leading powertrain is causing a loss of traction for the at least one trailing powertrain. Therefore, the herein described method may also use such a condition to trigger the action to be taken, i.e., the reduction of the maximum allowable wheel slip for the leading powertrain, in order to be able to address the problem more quickly and increase the likelihood of being able to meet a total motive force demand for the vehicle.

The step of controlling the leading powertrain in dependence of the reduced maximum allowable wheel slip for the leading powertrain may comprise controlling the propulsion force applied to the vehicle by the leading powertrain in dependence of the reduced maximum allowable wheel slip for the leading powertrain. This allows for an easy and reliable control of the leading powertrain and therefore also facilitates achieving a more appropriate force distribution between the plurality of mechanically separated powertrains to meet a total motive force demand for the vehicle.

The step of reducing the maximum allowable wheel slip for the leading powertrain may comprise reducing the maximum allowable wheel slip for the leading powertrain by a preselected value. This avoids having to determine an appropriate magnitude of adjustment, for example using a predetermined model therefore. Moreover, it allows for a smaller, stepwise, adjustment of the maximum allowable wheel slip which in turn may make the result more accurate.

The method may further comprise repeating the step of reducing the maximum allowable slip for the leading powertrain until the difference between the estimated road friction for the leading powertrain and the estimated road friction for the at least one trailing powertrain is within a predefined allowable range. This further ensures that the issue of the leading powertrain being the cause for a reduction or loss in traction of the at least one trailing powertrain being sufficiently addressed to allow a more appropriate force distribution between the plurality of mechanically independent powertrains to increase the total motive force that may be provided to the vehicle.

The method may further comprise a step of, in response to a determination that the estimated road friction for the at least one trailing powertrain has not been increased within a predetermined time after the step of controlling the leading powertrain in dependence of the reduced maximum allowable wheel slip for the leading powertrain, increasing the maximum allowable wheel slip for the leading powertrain. This ensures that the propulsion force that may be provided by the leading powertrain to the vehicle is not limited by the previous steps of the herein described method in case a reduction of wheel slip of the leading powertrain is not sufficient to increase the propulsion force that may be provided to the vehicle by the at least one trailing powertrain because of improved traction.

The present disclosure also relates to a control arrangement configured to control wheel slip in a vehicle. Said vehicle comprises a plurality of mechanically independent powertrains, each of said powertrains being configured to provide propulsion force to the vehicle via a respective set of drive wheels. The plurality of mechanically independent powertrains comprises, as seen in a driving direction of the vehicle, a leading powertrain and at least one trailing powertrain. The control arrangement is configured to monitor estimated road friction for the leading powertrain and estimated road friction for the at least one trailing powertrain. The control arrangement is further configured to, when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reduce a maximum allowable wheel slip for the leading powertrain. Moreover, the control arrangement is configured to control the leading powertrain in dependence of the reduced maximum allowable wheel slip for the leading powertrain.

The control arrangement provides the same advantages as described above with regard to the corresponding method for controlling wheel slip in a vehicle.

The control arrangement may further be configured to, when the estimated road friction for the at least one trailing powertrain drops to substantially zero while the leading powertrain has a wheel slip above a first limit, reduce the maximum allowable wheel slip for the leading powertrain.

The control arrangement may be configured to control the leading powertrain in dependence of the reduced maximum allowable wheel slip for the leading powertrain through controlling propulsion force applied to the vehicle by the leading powertrain in dependence of the reduced maximum allowable wheel slip for the leading powertrain.

The control arrangement may be configured to stepwise reduce the maximum allowable wheel slip by a preselected value until the difference between the estimated road friction for the leading powertrain and the estimated road friction for the at least one trailing powertrain is within a predefined allowable range.

The control arrangement may further be configured to, in response to a determination that the estimated road friction for the at least one trailing powertrain has not been increased within a predetermined time after the maximum allowable wheel slip for the leading powertrain has been reduced, increase the maximum allowable wheel slip for the leading powertrain.

The present disclosure also provides a computer program comprising instructions which, when executed by the above described control arrangement, cause the control arrangement to carry out the method for controlling wheel slip in a vehicle as described above.

Moreover, the present disclosure relates to a computer-readable medium having stored thereon the computer program as described above.

The present disclosure also relates to a vehicle. The vehicle comprises a plurality of mechanically independent powertrains, each configured to provide propulsion force to the vehicle via a respective set of drive wheels. The vehicle further comprises the above described control arrangement configured to control wheel slip in a vehicle.

The vehicle may be a land-based heavy vehicle, such as a bus, a truck or a truck-trailer combination, but is not limited thereto. The vehicle may be a fully electrical vehicle (such as a battery electric vehicle), a hybrid vehicle, or a fuel cell vehicle. Moreover, the vehicle may consist of a single vehicle unit or comprise at least two vehicle units.

### BRIEF DESCRIPTION OF DRAWINGS

FIG. 1 illustrates a side view of a first example of a vehicle,

FIG. 2 illustrates a side view of a second example of a vehicle,

FIG. 3 schematically illustrates an example of a powertrain of a vehicle,

FIG. 4 schematically illustrates an exemplifying embodiment of a vehicle comprising a first and a second powertrain that are mechanically separated from each other,

FIG. 5 represents a flowchart schematically illustrating one exemplifying embodiment of the herein described method for controlling wheel slip in a vehicle,

FIG. 6 schematically illustrates an exemplifying embodiment of a device which may comprise, consist of, or be comprised in the herein described control arrangement configured to control wheel slip in a vehicle.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

A vehicle is in the present disclosure considered to mean any means that may be used for transporting people and/or cargo. A vehicle may consist of a single vehicle unit. Examples of a vehicle consisting of a single vehicle unit includes a car, a rigid truck, a tractor truck, a bus, a self-powered trailer, or a self-powered dolly, but are not limited thereto. Alternatively, a vehicle may constitute a vehicle combination comprising at least two vehicle units which are physically linked when travelling. A vehicle combination may be a vehicle comprising a tractor vehicle and at least one trailing vehicle. Examples of vehicle combinations include a semi-trailer truck, a rigid truck pulling a semitrailer using a dolly, or a vehicle train comprising a rigid truck and one or more trailers, but are not limited thereto.

A vehicle powertrain comprises at least one power unit (also known as a propulsion unit) and a driveline configured to transmit propulsion force (and typically also braking force) to one or more drive wheels of the vehicle, said one or more drive wheels also constituting constituent components of the powertrain. The driveline typically comprises a transmission arrangement, which in turn comprises at least one transmission unit. A transmission unit may for example be a single speed transmission unit (also known as a single reduction gear) or a multispeed transmission unit. A driveline may further comprise one or more shafts, for example a drive shaft. A driveline may also comprise other types of components, such as one or more joint devices (e.g. universal joints or constant velocity joints), a clutch, a differential, etc.

In the present disclosure, two or more powertrains are considered to be mechanically independent from each other when there is no possibility for directly transmitting torque between said powertrains and the powertrains are connected to different drive wheels of the vehicle. In other words, two powertrains are mechanically independent when a power unit of one of the powertrains cannot transmit driving torque to the drive wheel(s) of the other powertrain and vice versa. Mechanically independent powertrains may alternatively be referred to as mechanically separated powertrains, and said terms are therefore used interchangeably in the present disclosure. One of the primary advantages of a presence of a plurality of mechanically independent powertrains in a vehicle, compared to a case of the vehicle comprising a single powertrain, is that it allows for controlling distribution of force, provided to the vehicle for the purpose of meeting a total motive force demand, between the mechanically independent powertrains to meet various objectives, such as energy efficiency and/or performance.

Furthermore, in the present disclosure, a distinction is made between a “leading powertrain” and a “trailing powertrain”. A leading powertrain shall be considered to be a powertrain arranged in front of a trailing powertrain as seen in a (current) direction of travel of the vehicle. In case a vehicle comprises more than two mechanically separated powertrains, a leading powertrain may, but need not be, the foremost powertrain, as seen in the travelling direction of the vehicle, of the plurality of powertrains. Thus, the terms “leading powertrain” and “trailing powertrain”, respectively, shall not be considered to refer to any particular relative position of said powertrains in the vehicle. A powertrain which may be regarded as a leading powertrain when the vehicle travels in a first direction may thus be a trailing powertrain when the vehicle travels in a second direction that is opposite to the first direction, and vice versa.

The present disclosure relates to a method for controlling wheel slip in a vehicle comprising a plurality of (i.e. two or more) mechanically independent powertrains. Each of the plurality of mechanically independent powertrains is configured to provide propulsion force to the vehicle via a respective set of drive wheels. Each of the plurality of mechanically independent powertrains may naturally further be configured to provide braking force to the vehicle via the respective set of drive wheels. The plurality of mechanically separated powertrains of the vehicle comprises, as seen in a (current) driving direction of the vehicle, a leading powertrain and at least one trailing powertrain.

According to one alternative, the leading powertrain and the at least one trailing powertrain are comprised in a common vehicle unit of the vehicle. This could for example be the case when the vehicle consists of a single vehicle unit, when the vehicle constitutes a vehicle combination where only a tractor vehicle unit comprises powertrains, or when the vehicle constitutes a vehicle combination comprising one vehicle unit comprising at least two of the mechanically separated powertrains and another vehicle unit comprising one or more additional powertrains. According to another alternative, the leading powertrain is comprised in a first vehicle unit of the vehicle and the at least one trailing powertrain is comprised in a second vehicle unit of the vehicle. In such a case, and assuming that the vehicle is travelling in a primary forward direction, the leading powertrain could for example be comprised in a tractor vehicle unit whereas the at least one trailing powertrain could be comprised in a trailing vehicle unit, although the present disclosure is not limited thereto. It should here be noted that when such a vehicle is reversed, the leading powertrain would be comprised in the trailing vehicle unit whereas the at least one trailing powertrain would be comprised in the tractor vehicle unit.

The herein described method for controlling wheel slip in the above described vehicle comprises a step of monitoring estimated road friction for the leading powertrain as well as estimated road friction for the at least one trailing powertrain. Estimation of road friction for a powertrain is as such previously known and may be made in accordance with any previously known method therefore, for example through usage of a predetermined model therefore in combination with data from various onboard sensors. Thus, the manner in which road friction is estimated does not limit the scope of the herein described method. In case the vehicle comprises more than two mechanically independent powertrains, the method may comprise monitoring estimated road friction for each of the mechanically independent powertrains of the vehicle.

The method further comprises a step of, when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reducing a maximum allowable wheel slip for the leading powertrain. The maximum allowable wheel slip for a powertrain of a vehicle is a control parameter used for the purpose of determining how the powertrain may be and/or should be controlled to avoid that the drive wheel exceed said maximum allowable wheel slip. Said control parameter may typically be selected to achieve desired traction while still allowing the vehicle to accelerate efficiently, and may be set in dependence of factors such as road conditions, vehicle dynamics and safety requirements.

As evident from the above, the herein described method considers the derivative of the difference in estimated road friction between the leading powertrain and the at least one trailing powertrain. The reason for considering the derivative of the difference in the estimated road friction of the leading powertrain and the estimated road friction for the at least one trailing powertrain is that the herein described method is intended to address the situation where the operation of the leading powertrain causes a relatively sudden and unexpected reduction, or even complete loss, of traction for the at least one trailing powertrain. In other words, the herein described method is not intended to address fluctuations in road friction that may be normally expected when driving the vehicle. Moreover, the reason for considering the derivative of the difference in estimated road friction between the leading powertrain and the at least one trailing powertrain, as opposed to a derivative of estimated road friction for the at least one trailing powertrain, is that it facilitates determining that the reason for the loss in road friction for the at least one trailing powertrain is due to the leading powertrain polishing or damaging the surface travelled by the vehicle.

Furthermore, in view of the herein described method seeking to overcome situations where the wheel slip of the leading powertrain is so high that it causes polishing or other damage to the surface travelled by the vehicle resulting in a substantial reduction of road friction from the at least one trailing powertrain, it is naturally only applicable to situations where the estimated road friction for the leading powertrain is greater than the estimated road friction for the at least one trailing powertrain. For other situations, wheel slip in the vehicle may be controlled in accordance with other previously known methods therefore. Thus, the herein described method is a method that may be used to supplement conventional methods for controlling wheel slip in a vehicle, and is applicable in particular to such situations where there is a sudden (and typically unexpected) drop in traction of a trailing powertrain.

The method further comprises a step of controlling the leading powertrain in dependence of the reduced maximum allowable wheel slip for the leading powertrain. More specifically, said step may comprise controlling the leading powertrain so that wheel slip for the set of drive wheels of the leading powertrain is equal to or lower than the reduced maximum allowable wheel slip. Through reducing the amount of wheel slip allowed for the drive wheels of the leading powertrain, the polishing or damage of the surface travelled by the vehicle may be reduced. This in turn increases the likelihood of the road friction for the at least one trailing powertrain to increase compared to a case where the maximum allowable wheel slip for the leading powertrain is not reduced.

Road friction is a key factor that determines how much of the motive force, generated by a powertrain of the vehicle, that may be effectively used to move the vehicle. Thus, when the road friction for the drive wheels of the at least one trailing powertrain is increased, the amount of motive force that may be applied to the vehicle by the at least one trailing powertrain increases. Although the leading powertrain may, as a result of being controlled in dependence of the reduced maximum allowable wheel slip for the leading powertrain, provide less motive force to the vehicle, the total motive force that may be applied to the vehicle by the plurality of mechanically independent powertrain may still be increased.

The method may further comprise a step of, when the estimated road friction for the at least one trailing powertrain drops to substantially zero while the leading powertrain has a wheel slip above a first limit therefore, reducing the maximum allowable wheel slip for the leading powertrain. In case the estimated road friction is substantially zero, the drive wheels of the trailing powertrain are slipping so much that traction for the at least one trailing powertrain is lost. The first limit for wheel slip is lower than the currently set maximum allowable wheel slip, and may be lower than the reduced maximum allowable wheel slip, for the leading powertrain. However, the first limit of wheel slip for the leading powertrain may typically be a relatively high wheel slip. In case the estimated road friction for the at least one trailing powertrain drops to substantially zero, there is no need to consider the above mentioned derivative in view of traction being lost for the at least one trailing powertrain. Thus, the step of reducing the maximum allowable wheel slip for the leading powertrain may be performed without considering the derivative of the difference between the estimated road friction for the leading powertrain and the estimated road friction for the at least one trailing powertrain. Naturally, the method still comprises the step of controlling the leading powertrain in dependence of the reduced maximum allowable wheel slip irrespectively of the reduction being occasioned by the above mentioned derivative being above a threshold or being occasioned by the estimated road friction for the at least one trailing powertrain dropping to substantially zero.

The step of controlling the leading powertrain in dependence of the reduced maximum allowable wheel slip for the leading powertrain may comprise controlling the propulsion force applied to the vehicle by the leading powertrain in dependence of the reduced maximum allowable wheel slip for the leading powertrain. This may in turn for example comprise adjusting power output from a power unit of the leading powertrain such that the wheel slip of the leading powertrain is equal to or lower than the maximum allowable wheel slip.

As previously mentioned, the herein described method comprises reducing the maximum allowable wheel slip. Said reduction of the maximum allowable wheel slip for the leading powertrain may suitably be made by reducing a currently set maximum allowable slip by a preselected value therefore. Such a preselected value for the reduction may for example be stored in a control arrangement configured to perform the method, or at least be retrieved by said control arrangement from a storage medium remote from the control arrangement. The preselected value may for example be based on historical data derived from the vehicle or other similar vehicles, or be determined through experimental tests or simulations made e.g., by the vehicle manufacturer. Alternatively, the reduction of the maximum allowable wheel slip may be made by a calculated value determined through usage of a predetermined wheel slip model for the vehicle with its plurality of mechanically independent powertrains.

The method may further comprise repeating the step of reducing the maximum allowable slip for the leading powertrain until the difference between the estimated road friction for the leading powertrain and the estimated road friction for the at least one trailing powertrain is within a predefined allowable range. Said predefined allowable range may be a range of an acceptable difference in road friction between the plurality of mechanically separated powertrains of the vehicle which ensures that the difference in wheel slip is acceptable and allows for a desirable force distribution between the mechanically separated powertrains. Suitably, the method may comprise repeating the step of reducing the maximum allowable wheel slip such that the maximum allowable wheel slip is reduced stepwise with the above mentioned preselected value until the difference between the estimated road friction for the leading powertrain and the estimated road friction for the at least one trailing powertrain is within the predefined allowable range.

The method may further comprise a step of, in response to a determination that the estimated road friction for the at least one trailing powertrain has not been increased within a predetermined time after the step of controlling the leading powertrain in dependence of the reduced maximum allowable wheel slip for the leading powertrain, increasing the maximum allowable wheel slip for the leading powertrain. When the estimated road friction of the at least one trailing powertrain is not increased after the leading powertrain has been controlled in dependence of the reduced maximum allowable wheel slip within the predetermined time, this means that a reduction of wheel slip for the leading powertrain is not sufficient to increase road friction and thereby improve traction for the at least one trailing powertrain. Thus, it may be more appropriate to seek to increase the propulsion force provided to the vehicle by the leading powertrain. This may in turn require an increase of maximum allowable wheel slip for the leading powertrain, for example up to a default maximum allowable wheel slip. Thereby, the propulsion force that may be provided by the leading powertrain to the vehicle is not limited by the previous steps of the herein described method.

The performance of the herein described method for controlling wheel slip may be governed by programmed instructions. These programmed instructions may take the form of a computer program which, when executed by a computer, cause the computer to effect desired forms of control action. Such a computer may for example be comprised in the control arrangement as described herein. A computer is in the present disclosure considered to mean any hardware or hardware/firmware device implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The above described programmed instructions, which may take the form of a computer program, may be stored on a computer-readable medium. Hence, the present disclosure also relates to a computer-readable medium storing instructions, which when executed by computer, cause the computer to carry out the herein described method for controlling wheel slip. The computer-readable medium may be a non-transitory computer-readable medium, such as a tangible electronic, magnetic, optical, infrared, electromagnetic, and/or semiconductor system, apparatus, and/or device.

The present disclosure further relates to a control arrangement configured to control wheel slip in a vehicle. The control arrangement may be configured to perform any one of the steps of the method for controlling wheel slip as described above.

More specifically, in accordance with the present disclosure, a control arrangement configured to control wheel slip in a vehicle is provided. The vehicle comprises a plurality of mechanically independent powertrains, each of said powertrains being configured to provide propulsion force to the vehicle via a respective set of drive wheels. The plurality of mechanically independent powertrains comprises, as seen in a driving direction of the vehicle, a leading powertrain and at least one trailing powertrain. The control arrangement is configured to monitor estimated road friction for the leading powertrain and estimated road friction for the at least one trailing powertrain. The control arrangement is further configured to, when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reduce a maximum allowable wheel slip for the leading powertrain. Moreover, the control arrangement is configured to control the leading powertrain in dependence of the reduced maximum allowable wheel slip for the leading powertrain.

The control arrangement may comprise one or more control units. In case of the control arrangement comprising a plurality of control units, each control unit may be configured to control a certain function/step or a certain function/step may be divided between more than one control units. The control arrangement may be comprised in a powertrain management system of the vehicle. Alternatively, the control arrangement may be any other control arrangement of the vehicle. In such a case, the control arrangement may be configured to communicate with a powertrain management system for the purpose of performing the herein described method.

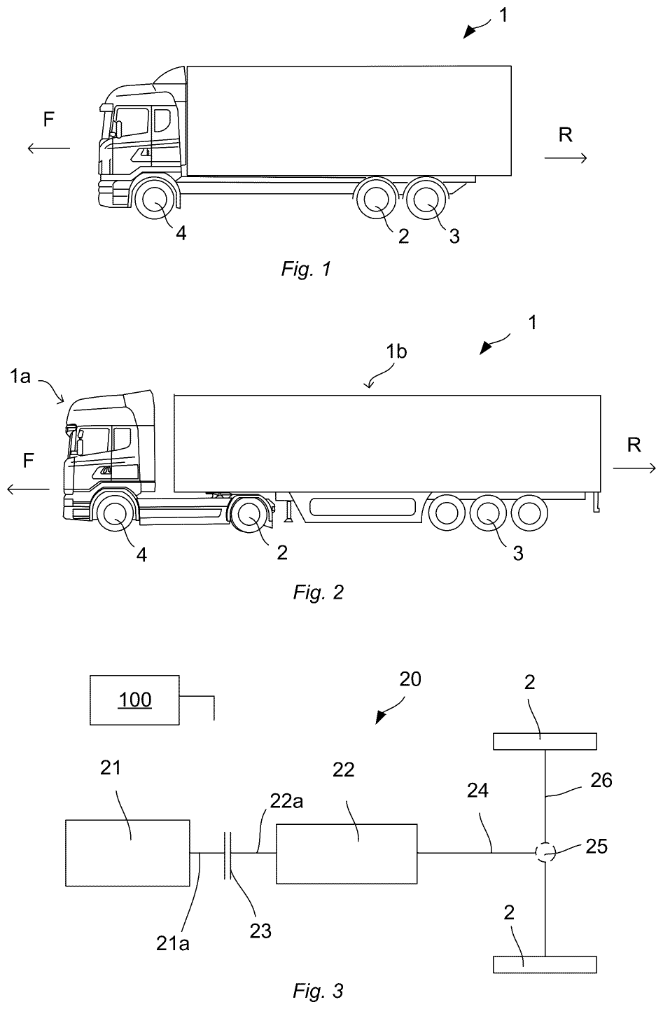

FIG. 1 illustrates a side view of a first example of a vehicle 1. The vehicle 1 is here illustrated as a rigid truck, and thus constitutes an example of a vehicle consisting of a single vehicle unit. The vehicle 1 comprises a first set of drive wheels 2 configured to be driven by a first powertrain (not shown) of the vehicle. The drive wheels 2 of the first set of drive wheels are typically evenly distributed on opposing sides of the vehicle 1, which is also the reason for only one of said first set of drive wheels 2 being visible in the figure. The vehicle 1 further comprises a second set of drive wheels 3 configured to be driven by a second powertrain (not shown) of the vehicle, said second powertrain being mechanically separate from the first powertrain. Like the first set of drive wheels 2, the second set of drive wheels comprises drive wheels 3 evenly distributed on opposing sides of the vehicle 1. The vehicle 1 further comprises front wheels 4. The front wheels 4 may typically be non-driven wheels but could alternatively be drive wheels.

A forward moving direction of the vehicle 1 is illustrated by the arrow F. The forward moving direction constitutes a primary moving direction of the vehicle 1. A reverse moving direction is in the figure illustrated by the arrow R. When the vehicle is travelling in the forward direction, the first powertrain configured to provide propulsion force to the first set of drive wheels 2 constitutes a leading powertrain and the second powertrain configured to provide propulsion force to the second set of drive wheels 3 constitutes a trailing powertrain. However, when the vehicle travels in the reverse direction, the second powertrain constitutes the leading powertrain and the first powertrain constitutes the trailing powertrain.

FIG. 2 illustrates a side view of a second example of a vehicle 1. The vehicle 1 is here illustrated as a semi-trailer truck, and is thus an example of a vehicle constituting a vehicle combination comprising at least two vehicle units. More specifically, the exemplified vehicle 1 comprises a first vehicle unit 1a in the form of a tractor vehicle (illustrated as a tractor truck) and a second vehicle unit 1b in the form of a trailing vehicle (illustrated as a semi-trailer). Like the vehicle shown in FIG. 1, the first vehicle unit 1a comprises drive wheels 2 configured to be driven by a first powertrain (not shown) of the vehicle 1. The first powertrain is comprised in the first vehicle unit 1a. The first vehicle unit further comprises front wheels 4, which may be non-driven wheels or drive wheels. The vehicle 1 further comprises a second set of drive wheels 3 configured to be driven by a second powertrain of the vehicle. In the illustrated case, the second set of drive wheels 3 are part of the second vehicle unit 1b. Thus, the exemplified vehicle 1 comprises a second powertrain comprised in the second vehicle unit 1b.

FIG. 3 schematically illustrates an example of a powertrain 20 of a vehicle, such as the vehicle 1 shown in either one of FIGS. 1 and 2. The exemplified powertrain 20 may for example constitute a first powertrain of a vehicle in case the vehicle 1 comprises at least two mechanically separated powertrains. The powertrain 20 may be configured to provide force (either propulsion or braking force, depending on the driving situation) to a set of first drive wheels 2. Said first drive wheels 2 are comprised in the powertrain 20.

The powertrain 20 comprises a first power unit 21, such as a combustion engine. Although not illustrated in the figure, the exemplified powertrain 20 may comprise further power units. For example, the powertrain 20 may in addition to a combustion engine comprise one or more electrical machines. The exemplified powertrain 20 further comprises a transmission arrangement 22. The transmission arrangement 22 may for example comprise, or consist of, an automated manual transmission, but is not limited thereto. The first power unit 21 of the exemplified powertrain 20 comprises an output shaft 21a connectable to an input shaft 22a of the transmission arrangement 22 via a clutch 23. An output shaft 24 of the transmission arrangement 22 may be connected to a drive shaft 26, with its associated drive wheels 2, typically via a differential 25.

The exemplified powertrain 20 may be controlled by a control arrangement 100 configured therefore. Said control arrangement 100 may be configured to perform the herein described method for controlling wheel slip in a vehicle.

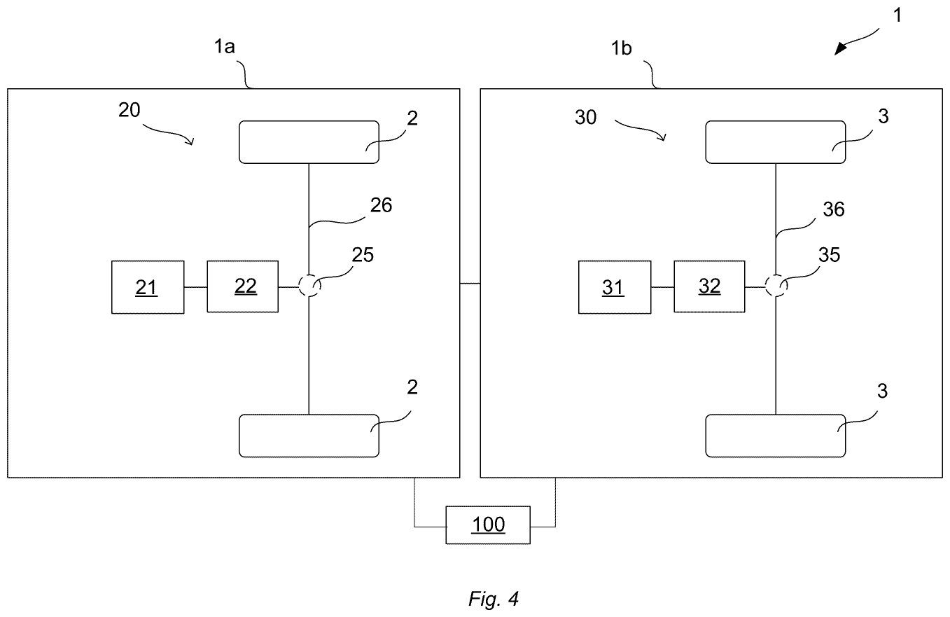

FIG. 4 schematically illustrates an exemplifying embodiment of a vehicle 1 comprising a first powertrain 20 and a second powertrain 30 that are mechanically separated from each other. The vehicle 1 is in the figure shown as a vehicle combination comprising a first vehicle unit 1a and a second vehicle unit 1b, and may thus for example correspond to the vehicle shown in FIG. 2. As shown in the figure, the first powertrain 20 of the vehicle 1 may be arranged in the first vehicle unit 1a whereas the second powertrain 30 may be arranged in the second vehicle unit 1b of the vehicle 1. It should however be noted that the first and second vehicle powertrains 20, 30 may alternatively be arranged in a common vehicle unit, for example in case the vehicle 1 would consist of a single vehicle unit (such as shown in FIG. 1). Furthermore, any one of the vehicle units 1a, 1b may comprise more powertrains than illustrated in the figure, if desired.

The first powertrain 20 comprises at least one first power unit 21, such as an electrical machine, configured to provide force (and thus also force) to a plurality of first drive wheels 2 of the vehicle 1. The first power unit 21 is connected to a first transmission arrangement 22 of the first powertrain 20. The transmission arrangement 22 is in turn connected to, optionally via a first differential 25, a first drive shaft 26. The first drive shaft 26 is in turn connected to the first drive wheels 2. The first drive shaft 26 and the first differential 25, if present, as well as the first drive wheels 2 are comprised in the first powertrain 20. The first powertrain 20 shown in FIG. 4 may for example constitute an electric drive axle, also known as an E-axle. Alternatively, the first powertrain 20 may have the same configuration as the exemplified powertrain shown in FIG. 3.

The second powertrain 30 comprises at least one second power unit 31 configured to provide force to a plurality of second drive wheels 3 of the vehicle 1. The second power unit 31 is connected to a second transmission arrangement 32, which in turn is connected to, optionally via a differential 35, to a second drive shaft 36. The second drive shaft 36 is in turn connected to the second drive wheels 3. The second transmission arrangement 32, the second drive shaft 36, the second differential 35 (if present), and the third drive wheels 3 are comprised in the second powertrain 30.

Depending on the driving direction of the vehicle 1, either one of the first powertrain 20 and the second powertrain 30 may serve as a leading powertrain whereas the other one of the first and second powertrains 20, 30 serves as a trailing powertrain, as already described above with reference to FIG. 1.

As shown in the figure, the vehicle 1 may further comprise a control arrangement 100. The control arrangement may be configured to control both the first powertrain 20 and the second powertrain 30. Moreover, the control arrangement 100 may be configured to perform the herein described method for controlling wheel slip in a vehicle.

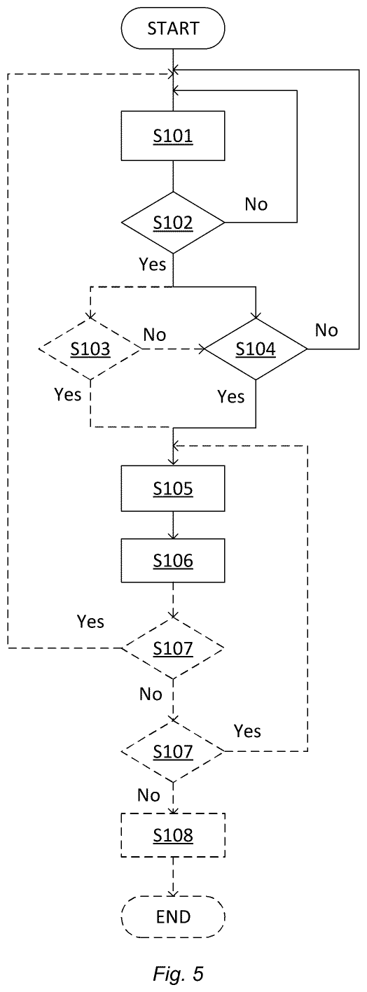

FIG. 5 represents a flowchart schematically illustrating one exemplifying embodiment of the herein described method for controlling wheel slip in a vehicle comprising a plurality of mechanically independent powertrains, such as the vehicle shown in FIG. 4. As seen in the current driving direction of the vehicle, the plurality of mechanically independent powertrains comprises a leading powertrain and at least one trailing powertrain. Optional steps of the exemplifying embodiment of the method are shown with dashed lines in the figure.

The method comprises a step S101 of monitoring estimated road friction for the leading powertrain as well as estimated road friction for the at least one trailing powertrain. It should here be noted that although step S101 is shown to be performed prior to other steps of the method, step S101 is continued to be performed even though the method proceeds to subsequent steps.

The method further comprises a step S102 of determining whether the estimated road friction for the leading powertrain is greater than the estimated road friction of the at least one trailing powertrain. In case the estimated road friction for the leading powertrain is not greater than the estimated road friction for the at least one trailing powertrain, the method may be reverted to start as shown in the figure. Otherwise, the method proceeds to subsequent step(s).

The method according to the exemplifying embodiment may further comprise a step S103 of determining whether the estimated road friction for the at least one trailing powertrain drops to substantially zero while the leading powertrain has a wheel slip above a first limit. If this is not the case, the method may proceed to the step S104 described below. Otherwise, the method may proceed directly to step S105 described below, which is also shown in the figure.

The method comprises a step S104 of determining whether a derivative of a difference between the estimated road friction for the leading powertrain and the estimated road friction for the at least one trailing powertrain is above a threshold. In case said derivative is not above the threshold, the method is reverted to start. However, in case the derivative of the difference between estimated road friction for the leading powertrain and the estimated road friction for the at least powertrain is above the threshold, the method proceeds to step S105.

Step S105 comprises reducing the maximum allowable wheel slip for the leading powertrain. Said reduction of the maximum allowable wheel slip for the leading powertrain may suitably be made by reducing a currently set maximum allowable wheel slip by a preselected value. Alternatively, the value by which the currently set maximum allowable wheel slip is to be reduced may be calculated using a predetermined wheel slip model for the vehicle comprising the plurality of mechanically independent powertrains.

The method further comprises a step S106 of controlling the leading powertrain in dependence of the reduced maximum allowable wheel slip for the leading powertrain. The step S106 may comprise controlling the propulsion force applied to the vehicle by the leading powertrain in dependence of the reduced maximum allowable wheel slip for the leading powertrain. After step S106, the method may be reverted to start. Alternatively, the method may optionally proceed to a step S107, as shown in the figure.

The optional step S107 comprises determining whether the difference between the estimated road friction for the leading powertrain and the estimated road friction for the at least one trailing powertrain is within a predefined allowable range. In case the difference between the estimated road friction for the leading powertrain and the at least one trailing powertrain is within the predefined allowable range, the method be reverted to start as shown in the figure. Alternatively, the method may be ended when the difference between the estimated road friction for the leading powertrain and the estimated road friction for the at least one trailing powertrain is within the predefined allowable range.

In case it is determined in step S107 that the difference between the estimated road friction for the leading powertrain and the estimated road friction for the at least one trailing powertrain is not within the predefined allowable range, the method may proceed to a step S108 of determining whether the estimated road friction for the at least one trailing powertrain has been increased within a predetermined time after step S106 was performed. In case the estimated road friction for the at least one trailing powertrain has been increased within the predetermined time, the method may be reverted back to step S105. Thereby, the step of reducing the maximum allowable wheel slip for the leading powertrain will be repeated until the difference between the estimated road friction for the leading powertrain and the estimated road friction for the at least one trailing powertrain is within the predefined allowable range mentioned above.

In case it is determined in step S107 that the estimated road friction for the at least one trailing powertrain has not been increased within a predetermined time after step S106, the method may comprise a step S108 of increasing the maximum allowable wheel slip. This may in turn allow maximizing the propulsion force provided by the leading powertrain to the vehicle, if desired. After step S108, the method may be ended.

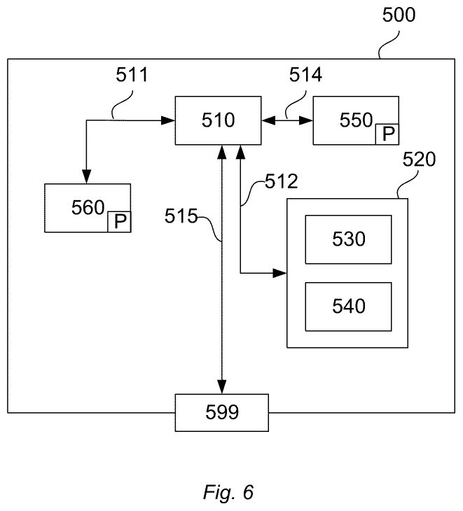

FIG. 6 schematically illustrates an exemplifying embodiment of a device 500. The control arrangement 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for controlling wheel slip in a vehicle, said vehicle comprising a plurality of mechanically independent powertrains. Each of said mechanically independent powertrains being configured to provide propulsion force to the vehicle via a respective set of drive wheels. The plurality of mechanically independent powertrains comprises, as seen in a driving direction of the vehicle, a leading powertrain and at least one trailing powertrain. The computer program comprises instructions for monitoring estimated road friction for the leading powertrain as well as estimated road friction for the at least one trailing powertrain. The computer program further comprises instructions for, when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reducing a maximum allowable wheel slip for the leading powertrain. The computer program further comprises instructions for controlling the leading powertrain in dependence of the reduced maximum allowable wheel slip for the leading powertrain.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be effected by the device 500 by means of the data processing unit 510 which runs the program stored in the memory 560 or the read/write memory 550. When the device 500 runs the program, methods herein described are executed.

1. A method, performed by a control arrangement, for controlling wheel slip in a vehicle, the vehicle comprising a plurality of mechanically independent powertrains, each of said powertrains being configured to provide propulsion force to the vehicle via a respective set of drive wheels, the plurality of mechanically independent powertrains comprising, as seen in a driving direction of the vehicle, a leading powertrain, and at least one trailing powertrain, the method comprising:
monitoring of estimated road friction for the leading powertrain and estimated road friction for the at least one trailing powertrain;
when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reducing a maximum allowable wheel slip for the leading powertrain; and
controlling the leading powertrain in dependence of the reduced maximum allowable wheel slip for the leading powertrain.

2. The method according to claim 1, further comprising:
when the estimated road friction for the at least one trailing powertrain drops to substantially zero while the leading powertrain has a wheel slip above a first limit, reducing the maximum allowable wheel slip for the leading powertrain.

3. The method according to claim 1, wherein controlling the leading powertrain in dependence of the reduced maximum allowable wheel slip for the leading powertrain comprises controlling the propulsion force applied to the vehicle by the leading powertrain in dependence of the reduced maximum allowable wheel slip for the leading powertrain.

4. The method according to claim 1, wherein reducing the maximum allowable wheel slip for the leading powertrain comprises reducing the maximum allowable wheel slip for the leading powertrain by a preselected value.

5. The method according to claim 1, further comprising repeating the step of reducing the maximum allowable wheel slip for the leading powertrain until the difference between the estimated road friction for the leading powertrain and the estimated road friction for the at least one trailing powertrain is within a predefined allowable range.

6. The method according to claim 1, further comprising:
determining that the estimated road friction for the at least one trailing powertrain has not been increased within a predetermined time after the step of controlling the leading powertrain in dependence of the reduced maximum allowable wheel slip for the leading powertrain; and
increasing the maximum allowable wheel slip for the leading powertrain.

7. A control arrangement configured to control wheel slip in a vehicle, the vehicle comprising a plurality of mechanically independent powertrains, each of said powertrains being configured to provide propulsion force to the vehicle via a respective set of drive wheels, the plurality of mechanically independent powertrains comprising, as seen in a driving direction of the vehicle, a leading powertrain, and at least one trailing powertrain, the control arrangement being configured to:
monitor estimated road friction for the leading powertrain and estimated road friction for the at least one trailing powertrain;
when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reduce a maximum allowable wheel slip for the leading powertrain; and
control the leading powertrain in dependence of the reduced maximum allowable wheel slip for the leading powertrain.

8. The control arrangement according to claim 7, further configured to:
when the estimated road friction for the at least one trailing powertrain drops to substantially zero while the leading powertrain has a wheel slip above a first limit, reduce the maximum allowable wheel slip for the leading powertrain.

9. The control arrangement according to claim 7, wherein the control arrangement is configured to control the leading powertrain in dependence of the reduced maximum allowable wheel slip for the leading powertrain through controlling propulsion force applied to the vehicle by the leading powertrain in dependence of the reduced maximum allowable wheel slip for the leading powertrain.

10. The control arrangement according to claim 7, wherein the control arrangement is configured to stepwise reduce the maximum allowable wheel slip by a preselected value until the difference between the estimated road friction for the leading powertrain and the estimated road friction for the at least one trailing powertrain is within a predefined allowable range.

11. The control arrangement according to claim 7, further configured to:
determine that the estimated road friction for the at least one trailing powertrain has not been increased within a predetermined time after the maximum allowable wheel slip for the leading powertrain has been reduced; and
increase the maximum allowable wheel slip for the leading powertrain.

12. A computer program product stored on a non-transitory computer-readable medium, said computer program product for controlling wheel slip in a vehicle, the vehicle comprising a plurality of mechanically independent powertrains, each of said powertrains being configured to provide propulsion force to the vehicle via a respective set of drive wheels, the plurality of mechanically independent powertrains comprising, as seen in a driving direction of the vehicle, a leading powertrain, and at least one trailing powertrain, wherein said computer program product comprising computer instructions to cause a control arrangement to perform the following operations:
monitor estimated road friction for the leading powertrain and estimated road friction for the at least one trailing powertrain;
when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reduce a maximum allowable wheel slip for the leading powertrain; and
control the leading powertrain in dependence of the reduced maximum allowable wheel slip for the leading powertrain.

13. (canceled)

14. A vehicle comprising:
a plurality of mechanically independent powertrains, each configured to provide propulsion force to the vehicle via a respective set of drive wheels, the plurality of mechanically independent powertrains comprising, as seen in a driving direction of the vehicle, a leading powertrain, and at least one trailing powertrain; and
a control arrangement configured to control wheel slip, the control arrangement being configured to:
monitor estimated road friction for the leading powertrain and estimated road friction for the at least one trailing powertrain,
when a derivative of a difference between the estimated road friction for the leading powertrain and the estimated road friction for the at least one trailing powertrain is above a threshold and the estimated road friction for the leading powertrain is greater than the estimated road friction for the at least one trailing powertrain, reduce a maximum allowable wheel slip for the leading powertrain, and
control the leading powertrain in dependence of the reduced maximum allowable wheel slip for the leading powertrain.
